(19) United States
(12) Patent Application Publication
(10) Pub. No.: US 2006/0196916 A1
(43) Pub. Date: Sep. 7, 2006

(54) Method and device for pressure welding, which takes into account deviations in the length of workpieces

(75) Inventors: Christian Goldstein, Friedberg (DE); Manfred Menzinger, Kissing (DE)

Correspondence Address: MCGLEW & TUTTLE, PC, P.O. BOX 9227, SCARBOROUGH STATION, SCARBOROUGH, NY, 10510-9227, US

(73) Assignee: KUKA SCHWEISSANLAGEN GMBH, Augsburg (DE)

(21) Appl. No.: 10/562,765

(22) PCT Filed: Jun. 30, 2004
(86) PCT No.: PCT/EP04/07064

§ 371 Date: Dec. 28, 2005

(30) Foreign Application Priority Data
Jul. 3, 2003 (DE) 103 30 188.7

(51) Int. Cl. B23K 20/12; B23K 31/02

(52) U.S. Cl. 228/114.5; 228/112.1

(57) ABSTRACT

A method and a device are provided for pressure welding, in particular for the friction welding or magnetic arc welding of workpieces (2, 3). The actual length of one or both workpieces (2, 3) and a potential length deviation (DELTA 1) from a target value is measured. If a length deviation exists, the target value of at least one parameter, in particular of the friction length, friction duration, arcing time or forge force is modified. A correction factor C, by which the length deviation (DELTA 1) is multiplied, is determined for this modification. The pressure welding device (1) includes a corresponding measuring unit (12) for determining workpiece lengths and length deviations. The controller (13) comprises an arithmetic unit (14) for setting and modifying target values, taking into account the correction factor C.

### CROSS REFERENCE TO RELATED APPLICATIONS

This application is a United States National Phase application of International Application PCT/EP2004/007064 and claims the benefit of priority under 35 U.S.C. § 119 of German Application DE 103 30 188.7 filed Aug. 6, 2002, the entire contents of which are incorporated herein by reference.

### FIELD OF THE INVENTION

The present invention pertains to a process and a device for pressure welding, preferably friction welding or Magnet arc welding of workpieces

### BACKGROUND OF THE INVENTION

Various embodiments of such processes and devices have been known from practice, e.g., as friction welding machines or magnet impelled arc welding machines. The pressure welding processes can be managed in practice while maintaining the required welding quality when the length tolerances of the workpieces or components to be welded together are within relatively narrow limits and the overall length of the welded components is not subject to narrower tolerances. Problems arise when the tolerance specifications for the individual lengths of the workpieces to be welded together are relaxed and/or the tolerances for the overall length of the finished, welded component are tightened at the same time. Corresponding constant specifications are set for the friction duration (time) or the friction path length in practice for the particular application, e.g., in case of friction welding and especially in case of the relative time-friction or path-friction, the specification taking place starting from the contact of the components and regardless of the initial position of the workpieces. Depending on the length of the components before welding, overall lengths that deviate from the required length after the friction welding by the error of the initial position are obtained. This means that the welded components are either too short or too long in case of great, still tolerable errors in the initial positions.

To eliminate this problem, it is known from practice in friction welding that friction is performed to a certain absolute path. The two workpieces are rubbed against one another after the components have come into contact with one another until a preset carriage position is reached. After this position has been reached, the process is switched over to forge pressure (compressive pressure), the compressive stroke being carried out with a preset force and without control of the forge path. However, there is a risk in this variant that the friction length (friction path length) is not long enough in case of components that are too short and late contact of the components. Comparatively little frictional work is introduced now, which leads to a lower forge shortening and, as a result, to excessive overall length of the welded components because of insufficient plasticization. The opposite happens in case of workpieces that are too long. The friction length, prolonged by early contact of the components. leads to a higher frictional work and greater plasticization of the workpieces in the area of the contact, which leads to shortening of the component during the subsequent forge stroke.

The largest part of the energy needed is introduced during the braking of the spindle during short-time friction welding. The friction duration times usually range from 0 to approx. 0.5 sec. This parameter variant is usually used to weld nonferrous metals, for the combinations of these metals with one another, and for combinations of nonferrous metals with steel. The component length after welding is also set here by selecting the forge pressure or the forge force. The same problems arise as in the case of the other pressure welding processes when the final tolerances are tightened and the initial tolerances of the individual components are relaxed.

DE 34 13 203 C2 discloses a process for controlling a centrifugal force or friction welding operation. The feed path or the so-called amount of compressive/forge or the feed time during the initial friction phase and forge phase are always maintained at constant values and adjusted when process anomalies appear. This is done by affecting and changing the pressing pressure. The reference or set values for the feed path or the feed time are obtained from test weldings. They remain constant during serial operation and are not changed. Internal control of the actual values of path or time of the feed is performed by changing the pressure and also only during the process in response to any possible deviations in feed that occur during the process. The length of the components is not measured before welding during serial operation. Even though length deviations of the components can be compensated by controlling the feed such that it has a constant value, this happens only in the area of the friction phase due to the fixed specification of the set point. In case of excessive length of the components, the consequence of this is an excessively prolonged friction phase with excessive plasticization. If the length of the components is too short, the friction phase and the plasticization are too small. The changes made in the pressing pressure in the process ensure continuously changed welding conditions. The quality of welding is subject, as a result, to incalculable changes and its constancy cannot be preserved. The length compensation of the components is, as a result, to the detriment of the welding quality.

### SUMMARY OF THE INVENTION

The object of the present invention is to provide a better process along with a device for pressure welding, which can meet the changed tolerance requirements.

This object is accomplished by the present invention with the present invention making possible the pressure welding of workpieces with precise tolerances while maintaining the required welding quality. By determining any length deviations that may occur in the workpieces to be welded together, the initial tolerance error can be accurately determined and compensated by changing the set points of one or more welding parameters before the subsequent welding operation. The length deviation Δ1 determined is compensated by changed plasticization and a changed forge stroke. Depending on the length deviation determined, the distribution ratio can be set optimally by means of a correction factor C. The plasticization of the workpiece is preferably affected now by means of one or more suitable process parameters and the correction factor C. The fitting length of the forge stroke will then become established in the process by itself on the basis of the plasticization conditions.

The claimed process and the device can be used for many different types of pressure welding processes. Preferred fields of application are friction welding and magnet impelled arc welding with magnetically moving arc. The process parameters friction length, friction duration or forge pressure can be changed during friction welding individually or in combination. For example, the time or velocity of circulation of the arc or the forge force are suitable in case of magnet impelled arc welding.

Adapted correction factors C can be used for the different process parameters. The correction factors C are preferably obtained in test series in an application-dependent manner and are stored in a technology data bank. Furthermore, it is possible in this connection to determine different correction factors C from tests for different initial lengths of the workpieces or components or for different length deviations Δ1 and to form length-dependent limit values. The correction factor necessary for the particular length deviation Δ occurring can be obtained from this in serial operation by interpolation between the length-dependent limit values.

The present invention is schematically shown in the drawings as an example. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view and a side view of a friction welding device;

FIG. 2 is a view showing a component and feed lengths, in a first of three different variants, for components with correct length;

FIG. 3 is a view showing a component and feed lengths, in a second of three different variants, for components with excessively long length;

FIG. 4 is a view showing a component and feed lengths, in a third of three different variants, for components with excessively long short length;

FIG. 5 is a diagram of the path, speed and forge pressure as a function of the time during path friction welding with length compensation;

FIG. 6 is a diagram of the path, speed and forge pressure as a function of the time during time-friction welding with length compensation; and

FIG. 7 is a diagram of the path, speed and forge pressure as a function of the time during short-time friction welding with length compensation.

### DESCRIPTION OF THE PREFERRED EMBODIMENTS

Referring to the drawings in particular, the present invention pertains to a process and a device (1) for pressure welding of workpieces (2, 3), which are at first plasticized on their adjacent abutting boundary surfaces while being heated and are subsequently joined by an forge stroke. The exemplary embodiments shown pertain to friction welding, where the workpieces (2, 3) are rubbed against one another under pressure and by rotation and are plasticized by the frictional heat. An arc is ignited between the workpieces kept at spaced locations from one another and caused by a magnetic field to perform a rotary movement in case of magnet impelled arc welding with a magnetically moved arc. The abutting boundary surfaces of the workpieces are heated by the arc. Such a magnet impelled arc welding process is described, for example, in DE41 35 882 A1.

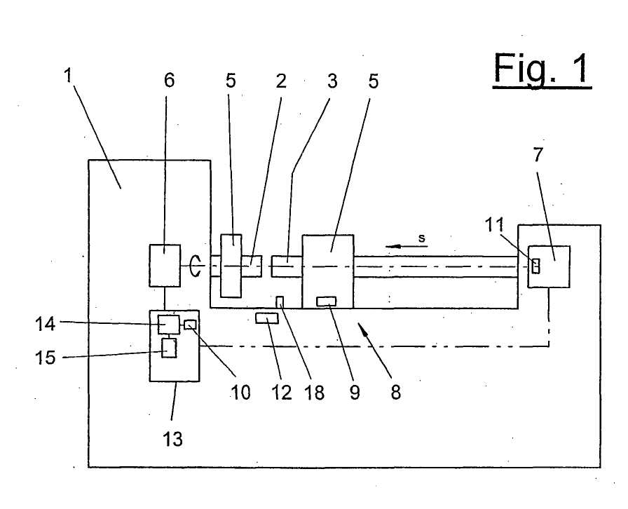

FIG. 1 shows the pressure welding device in the form of a friction welding machine (1). It comprises a machine frame with two movable clamping means (5) for the two workpieces (2, 3) to be welded together. One clamping means (5) is connected to a rotating unit (6), which allows the workpiece (2) to rotate about its longitudinal axis. The other workpiece (3) is connected to an axial feed unit (7), with which it can be fed in relation to the rotating workpiece (2) in the direction of feed s. The rotating unit (6) has a suitable rotating drive, e.g., an electric motor, which can be controlled and regulated, and which drives the clamping means (5) directly. As an alternative, a flywheel drive may be used instead of a direct motor drive. The feed unit (7) likewise has a suitable drive, e.g., a hydraulic cylinder for feeding the clamping means (5).

The friction welding machine (1) has a measuring means (8), which may have different designs and different measuring elements. These may be, for example, a path-measuring unit 9 for measuring the feed of the workpiece (3), a time-keeping unit (10), a force- or pressure-measuring unit (11) at the feed unit (7) and optionally a length-measuring unit (12). The rotating unit (6) and the feed unit (7) as well as the measuring means (8, 9, 10, 11, 12) are connected to a control (13) of the friction welding machine (1), which has an electronic computing unit (14) with at least one memory (15) for process parameters, programs and other data. The time-keeping unit (10) may be associated with the computing unit (14).

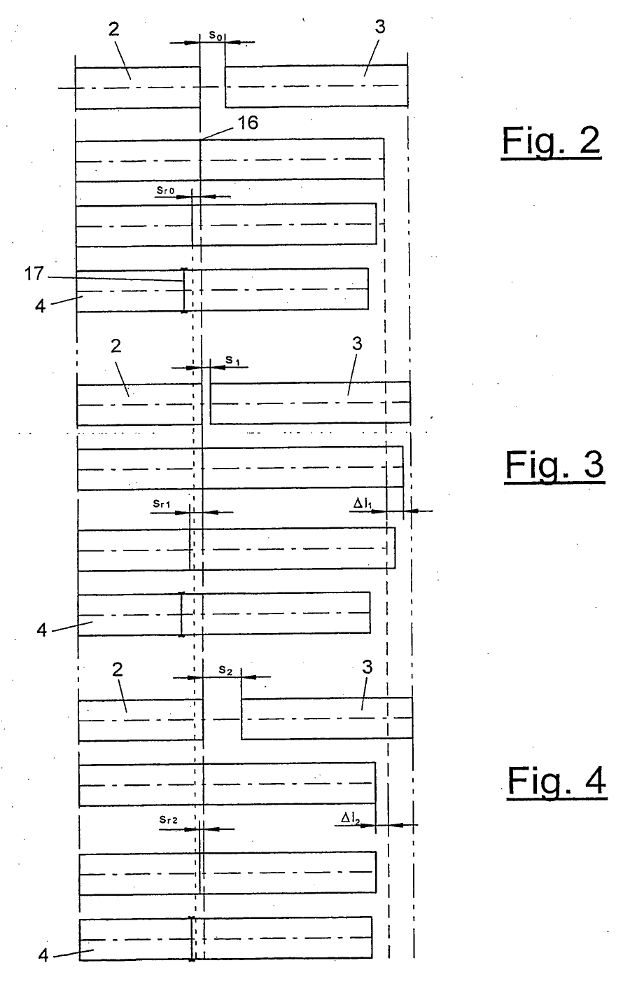

FIGS. 2 through 4 illustrate different situations concerning the initial workpieces (2, 3) and the welded component (4). FIG. 2 shows the arrangement in the friction welding machine (1) in case of two workpieces (2, 3), which have exactly the desired length. The two workpieces (2, 3) are attached to their clamping means (5) at axially spaced locations from one another, and they are tightly in contact with a respective rearward stop in the clamping means (5), the position of the said stop in the axial direction or the direction of feed s being exactly known. A distance of a feed path so, by which the feed unit (7) must displace the workpiece (3) axially until it comes into contact with the other workpiece (2) is obtained in case of the correct workpieces (2, 3). The feed path s₀ can now be determined accurately by means of the length-measuring unit (12), e.g., a contact sensor. The exact length of the two workpieces (2, 3) in the contact position can be determined from this fed path s₀ and the known position of the rearward stops in the clamping means (5). As an alternative, the initial length of the two workpieces (2, 3) can be determined in any other suitable manner as well.

As soon as the two workpieces (2, 3) are in contact with one another at the so-called zero point (16) according to the second view in FIG. 2, they are rotated relative to one another with their contact surfaces under pressure. The workpiece (3) is fed farther by the feed unit (7) over the friction length sᵣ₀. The friction length sᵣ₀ is set as the process parameter in case of path-friction welding. In the alternative time-friction welding, the friction duration t₀ is set as a process parameter at a given and preferably constant friction pressure or feed force. As soon as the preset friction length sᵣ₀ or the preset friction duration t₀ has been completed, the rotary movement is stopped and the workpiece (3) is moved axially forward in the forge stroke. The rotating drive may also be switched off at an earlier point in time.

During the forge stroke, the material plasticized by the frictional heat is displaced radially toward the outside at least partially in the contact area of the abutting boundary surfaces, forming a friction weld bead or flashline, as a result of which the component lengths decrease further and the weld seam (17) moves farther away from the zero point (16) by a certain amount. The third view in FIG. 2 shows the situation of the workpiece at the end of the friction length sᵣ. The fourth view shows the completely welded component (4) and the length thereof. The displacements and paths are plotted on one side only, contrary to the actual conditions, for the sake of simplicity and clarity.

FIG. 3 illustrates the situation in the case of workpieces (2, 3) with excessive length. The workpiece (3) is longer than the set value in the case being shown. The other workpiece (2) corresponds, by contrast, to the set value. This is likewise a simplified view and may also be different in practice.

As is illustrated by the first view in FIG. 3, the feed s₁ from the initial position until the workpieces (2, 3) come into contact with one another becomes shorter due to the excessive length of the workpieces (2, 3). The length deviation Δ1 arising from this by comparison with s₀ in the overall length of both workpieces (2, 3) is illustrated in the second view in FIG. 3. If the welded component (4) is to have the correct final length despite the excessive length of the workpieces (2, 3), the length deviation Δ1₁ must be compensated during the friction welding operation. This is achieved by changing the set value and by making the friction length sᵣ₁ longer. The friction length sᵣ₁ is, however, shorter than the length deviation Δ1₁, which is set by a correction factor Cₛ or Cₜ for the friction length or the friction duration, which will be explained in greater detail below.

The fact that the forge path also increases in case of a longer friction length is taken into account by the correction factor Cₛ or Cₜ for the set values of the process parameters during path- or time-friction welding during the compensation of the Δ1₁. More frictional work is introduced at the contact site by the longer friction length or the longer friction duration, which leads to higher plasticization of the boundary surfaces, so that more material can be displaced from the contact area during the forge stroke carried out with constant force, which increases the length of the forge stroke.

FIG. 4 illustrates the other case, the excessively short length of both workpieces (2, 3) and the correspondingly longer feed s₂. The length deviation Δ1₂ of both workpieces (2, 3) has a negative sign for distinction from the excessive length. The friction length sᵣ₂ is shorter in case of excessively short length than in case of correct desired length of the workpieces (2, 3) or in case of excessive length. However, the friction length or the friction duration times are selected to be so high due to the correction factor Cₛ or Cₜ that the heating and the plasticization of the workpieces (2, 3) are sufficient for arriving at a correct overall length of the welded component (4) in conjunction with the forge stroke, which is correspondingly shortened compared to the other exemplary embodiments.

The correction factor Cₛ or Cₜ thus also has the function of a distribution factor in the cases described, which determines the amount of the change in the friction length and forge path or of the friction duration and forge time during the compensation of the length deviation Δ1₁.

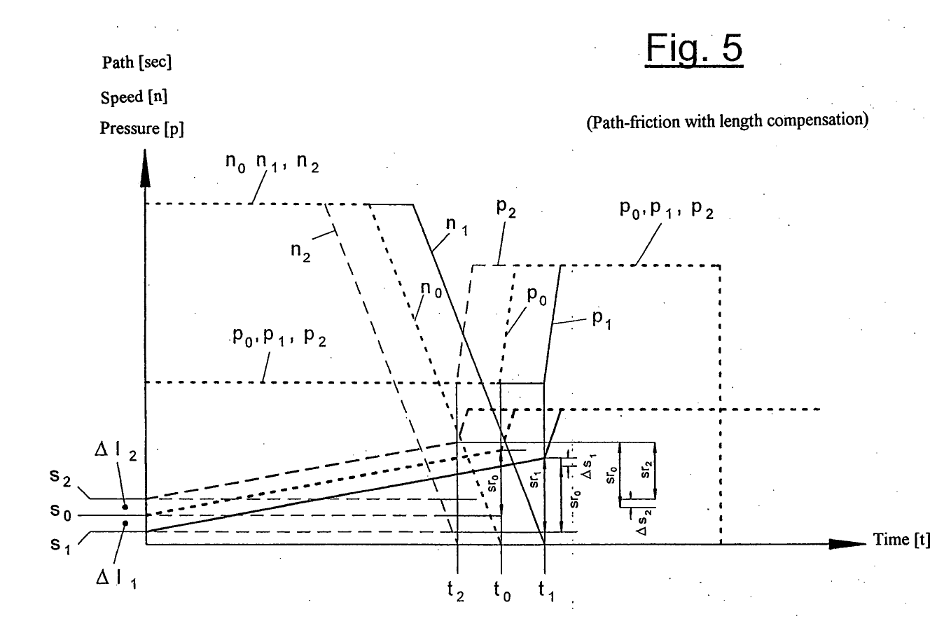

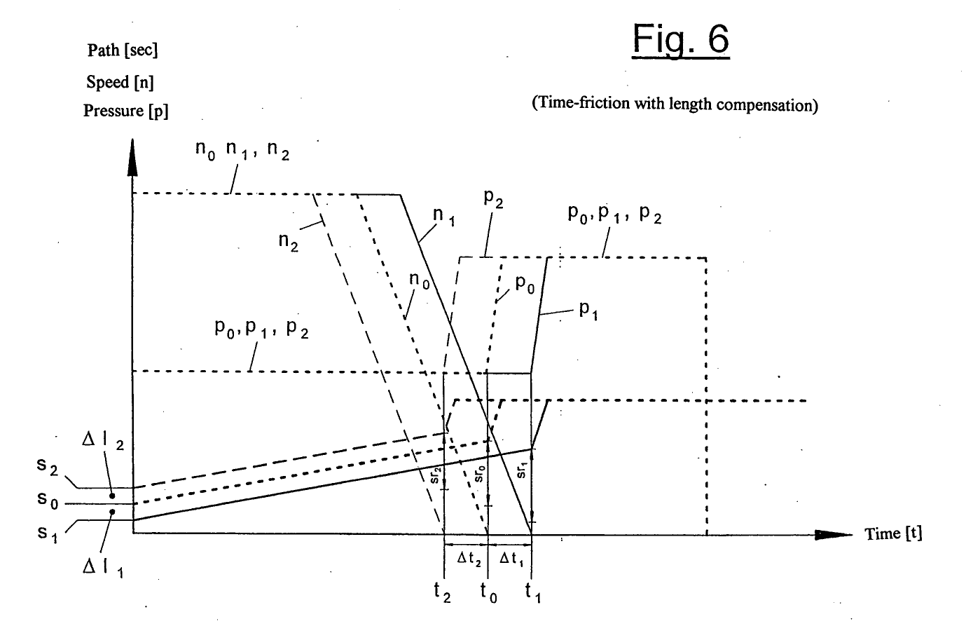

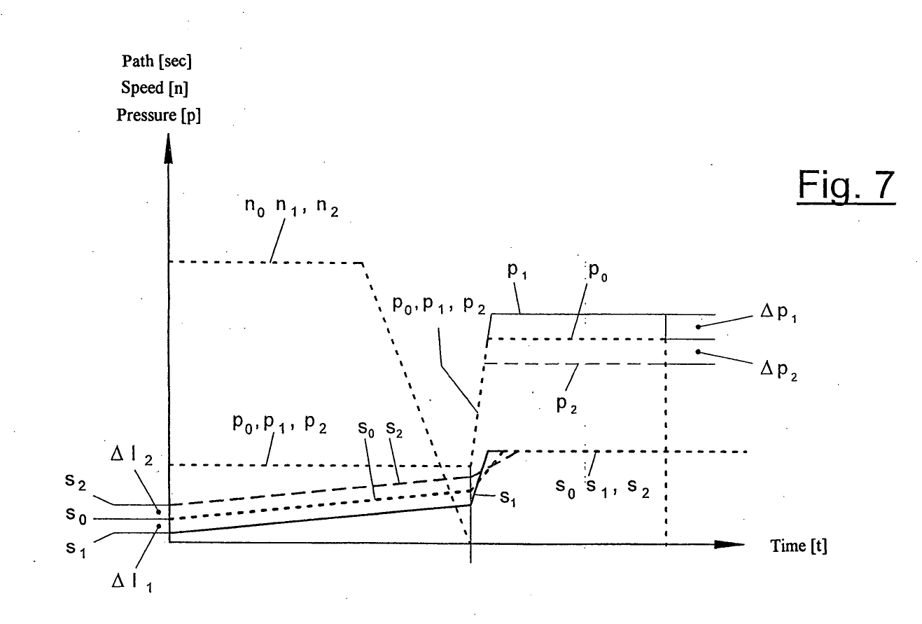

The diagrams in FIGS. 5 and 6 show the ratios of the path s of the feed and of the workpiece (3), the speed n of the workpiece (2) being rotated and of the forge pressure or of the forge force p of the feed unit (7) as a function of the time. The values s₁, n₁ and p₁ indicate here the ratios in case of excessive length of the workpieces (2, 3). The values s₂, n₂ and p₂ stand for the other variant of excessively short length of the workpieces (2, 3). The values s₀, n₀ and p₀ represent the normal ratios in case of the desired length of the workpieces (2, 3).

The length deviation Δ1₁, Δ1₂ is compensated by a change in the friction length sᵣ and of the corresponding feed of the feed unit (7) in conjunction with the subsequent forge pressure in the case of the path-friction welding shown in the diagram in FIG. 5. The following conditions apply now:
sᵣ₁=sᵣ₀+Δs₁
sᵣ₂=sᵣ₀+Δs₂.
Δs₁ indicates the change in the friction length in case of excessive length of the workpieces (2, 3) and leads to a longer friction length sᵣ₁. Δs₂ applies to the change in the friction length in case of excessively short length and correspondingly has a negative sign, which leads as a consequence to shorter friction sᵣ₂.

Taking the correction values Cₛ into account, the necessary changes in the friction length are calculated according to the following formula:
Δs₁=Δ1₁*Cₛ
Δs₂=Δ1₂*Cₛ.
The length deviations Δ1₁ and Δ1₂ depend on the sign. A negative sign is obtained in case of excessively short length.

The process parameter of the friction duration t is set and changed in case of the time-friction welding illustrated in FIG. 6 with length compensation, and a corresponding friction length is obtained along with an forge path. The following formulas apply to this:
t₁=t₀+Δt₁
t₂=t₀+Δt₂.
In these cases, t₀ is the friction duration applying to the desired length of the workpieces (2, 3). t₁ and t₂ are the prolonged or shortened friction duration times in case of excessive length or excessively short length of the workpieces (2, 3).

The changes Δt in the friction duration times are calculated as follows:
Δt₁=Δ1₁*Cₜ
Δt₂=Δ1₂*Cₜ.
A comparison of the diagrams in FIGS. 5 and 6 shows that the compensations taking place during path-friction welding and during time-friction welding are qualitatively equal. Depending on the length deviation Δ1, equal increase or decrease in the friction and forge paths takes place in both cases, but this is achieved in a path-controlled manner in one case and in a time-controlled manner in the other case.

A third friction welding process, the so-called short-time friction welding, is suitable for certain material combinations, especially for nonferrous metals in the pure form, in the mixed form with other nonferrous metals or in the mixed form with steel or other materials. Such a welding process is described, for example, in WO 97/01412. The two workpieces (2, 3) are rotated here for a very short time only or over a limited angle of rotation in a frictionally engaged manner and are subsequently upset. The forge force or, in case of hydraulic feed units (7), the forge pressure is a suitable process parameter in this case. To compensate length deviations Δ1₁, Δ1₂, the forge force or the forge pressure is changed, the friction duration or the angle of rotation remaining equal regardless of the length of the workpiece. Excessive length of the workpieces (2, 3) is compensated by increasing the forge force/forge pressure and excessively short length is compensated by reducing the forge force/forge pressure. The forge paths change correspondingly, so that the welded components (4) will again have the correct desired length at the end despite different individual lengths of the workpieces (2, 3).

The following formulas apply now:
p₁=p₀+Δp₁
p₂=p₀+Δp₂
p₀, p₁ and p₂ are the values for the forge force/forge pressure at desired length, excessive length and excessively short length of the workpieces (2, 3). Δp₁ and Δp₂ concern the change in the forge force/forge pressure in case of excessive length and excessively short length, and Δp₂ will again have a negative sign corresponding to the length deviation Δ1₂.
The changes in the forge force/forge pressure are calculated as follows:
Δp₁=Δ1₁*Cₚ
Δp₂=Δ1₂*Cₚ.

The correction values Cₛ, Cₜ and Cₚ, which will summarily be designated as the correction value C below, are preferably obtained empirically in test series and related to the particular valid length deviation Δ1. The correction factors C are determined in the test series in an application-dependent manner and preferably on the basis of sample workpieces from the series batch. The test series are carried out separately according to the different pressure welding processes, for example, the path-, time- or short-time friction welding process. The changes in the friction length, friction duration and forge force/forge pressure are varied stepwise within the test series with a plurality of workpieces each time with given desired length, friction duration and forge force/upset stroke, and the welded components (4) are subsequently checked for their overall length and tolerance deviation as well as additionally also for the welding quality. Corresponding tests are performed with respect to the welding quality. The changes in the friction length, friction duration and forge force/forge pressure with reference to the desired length and a certain excessive length and a certain excessively short length that lead to correct final lengths and welding qualities of the components (4) appear from the test series. The correction factors C are calculated here from the particular ratio of the correct changes in the friction length, friction duration and forge force/forge pressure at a given length deviation Δ1. The correction factors may be obtained in many cases as constants, which remain essentially equal for all the length deviations Δ1 that are within the preset tolerance range. If the correction values C vary, upper and lower limits are determined for the particular corresponding maximum length deviations Δ1 for the excessive length and the excessively short length, between which interpolation can be performed during the later serial operation. The correction values C determined are stored in the memory (15) of the control (13), optionally as a pair of values together with the length deviation Δ1, to which they apply. The correction values C are determined and stored separately for the different applications and the different friction welding processes.

The actual length of the workpieces (2, 3) and a possible length deviation Δ1 are first determined in the pressure welding device (1) during serial operation by the length-measuring unit (12) and reported to the control (13). The computing unit (14) polls the stored corresponding correction value C and calculates on the basis of this value the necessary change in the set value for the friction length, the friction duration or the forge force/forge pressure and then controls the friction welding operation correspondingly. If certain welding programs are run during the different pressure welding processes, the correction values C in these welding programs can be entered and stored as program parameters.

The affected process parameters are changed in the exemplary embodiments described in a simple linear function with constant correction values C. This is sufficient for many applications. As an alternative, it is possible for other and possibly complicated applications to change the affected process parameters in terms of their characteristics, especially with a parameter profile that is subject to changes in time and/or position. This may present itself, e.g., in the above-mentioned welding programs. The correction values C may be variable and, moreover, variable in a nonlinear manner by being, e.g., a function of the time and/or of the path.

The process parameters and correction values C set as well as the permanently or occasionally determined measured values for the feed path(s) (e.g., until the components come into contact, until the end of the friction length and until the end of the forge stroke), component lengths, length deviation Δ1, time, forge force/forge pressure, etc., are recorded and stored by the control during serial welding operation with assignment to the individual workpieces. This is, on the one hand, advantageous for the quality testing and documentation.

The stored values may, moreover, also be compared with one another for process monitoring and optionally also for controlling the process in order to make it possible to detect and eliminate a drift of the machine or other errors that occur during the operation temporarily and possibly in a variable manner. If, e.g., the component lengths and the length deviations Δ1 vary within narrow limits only in a batch of components and the overall feed paths nevertheless deviate more greatly from one another, this argues in favor of a drift in the material of the component or in the process behavior, which can be eliminated, e.g., by a correction of a process parameter, which is performed by the control automatically on the basis of a monitoring and control program, and/or of a correction value C.

In addition, a plausibility monitoring of the welding processes and of the process parameters or correction values C set may be performed in order to prevent incorrect weldings with certainty. Moreover, a stop (18), with which the feed and especially the forge stroke can be limited to a maximum, may be present in the pressure welding machine (1).

Various variants of the embodiments described are possible. This applies, on the one hand, to the type of the pressure welding process and the devices (1) used therefor. On the other hand, other process parameters may also be set, depending on the welding technique, and they can be changed taking into account correction values C. Preferably only one process parameter is changed during the pressure welding process for compensating length deviations Δ1. As an alternative, a plurality of process parameters are changed.

While specific embodiments of the invention have been shown and described in detail to illustrate the application of the principles of the invention, it will be understood that the invention may be embodied otherwise without departing from such principles.

1. A process for pressure welding, friction welding or Magnetarc welding of workpieces the process comprising the steps of:
measuring the actual length of one or both of said workpieces and a possible length deviation Δ1 from a set value;
changing a set value of at least one process parameter from process parameters comprising: friction length, friction duration, arc time and forge force, in case of length deviations; and
determining a correction factor C, by which a length deviation Δ1 is multiplied; for the change.

2. A process in accordance with claim 1, wherein said correction factor C is obtained empirically in a test series.

3. A process in accordance with claim 1, wherein said correction factor C is determined in an application-dependent manner.

4. A process in accordance with claim 2, wherein the test series are carried out in an application-specific manner on sample workpieces from a series batch.

5. A process in accordance with claim 1, wherein the welding quality is taken into account in the determination of said correction factor C.

6. A process in accordance with claim 1, wherein upper and lower limits for length deviations Δ1 and for said corresponding correction factors C are determined and stored, and said correction factor C is determined during the welding operation for measured length deviations Δ1 in this range by interpolation.

7. A process in accordance with claim 1, wherein a change in friction length, Δs, is calculated as a product of a correction factor Cₛ by the length deviations Δ1 in case of friction welding with friction length control.

8. A process in accordance with claim 1, wherein a change in friction duration, Δt, is calculated as the product of a correction factor Cₜ by the length deviations Δ1 in case of friction welding with friction duration control.

9. A process in accordance with claim 1, wherein a change in the forge stroke, Δp, is calculated as the product of a correction factor C by the length deviations Δ1 in case of friction welding with short-time control.

10. A process in accordance with claim 1, wherein the forge force is changed.

11. A process in accordance with claim 1, wherein the process parameter is changed in terms of its characteristic, with a parameter profile varying in time and/or space.

12. A process in accordance with claim 1, wherein determined correction values C with reference data for said workpieces are stored in a data bank which can be connected to a pressure welding machine performing the welding.

13. A device for pressure welding, friction welding or Magnetarc welding of workpieces, the device comprising:
a feed unit,
a control, and
a measuring means for determining the actual length of one or both of said workpieces and a length deviation Δ1, wherein a set value of at least one process parameter comprising friction length, friction duration, arc time or forge force is changed in said control in case of a length deviation Δ1, said control having a computing unit for setting and changing set values, taking a correction factor C for said at least one process parameter into account.

14. A device in accordance with claim 13, wherein said control is programmable, wherein said computing unit is connected to at least one memory and has a program for determining, or interpolating, the correction factor C from stored preset values.
